(19) United States
(12) Patent Application Publication
(10) Pub. No.: US 2009/0211610 A1
(43) Pub. Date: Aug. 27, 2009

(54) METHOD FOR TREATING A SUBSTRATE

(75) Inventors: Yasushi Honbe, Nagasaki (JP); Hitoshi Abe, Nagasaki (JP); Hayato Iwamoto, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: Sony Corporation, Tokyo (JP)

(21) Appl. No.: 12/368,662

(22) Filed: Feb. 10, 2009

(30) Foreign Application Priority Data
Feb. 23, 2008 (JP) 2008-042268

(51) Int. Cl. B08B 3/08

(52) U.S. Cl. 134/26

(57) ABSTRACT

Disclosed herein is a method for treating a substrate wherein a chemical is fed to a surface of the substrate, the method including the steps of: initially feeding a liquid whose electric conductivity is lower than the chemical to a surface of the substrate so as to wet at least a region where the chemical is to be discharged, and discharging the chemical to the region to treat the surface of the substrate with the discharged chemical.

### CROSS REFERENCES TO RELATED APPLICATIONS

The present invention contains subject matter related to Japanese Patent Application JP 2008-042268 filed in the Japan Patent Office on Feb. 23, 2008, the entire contents of which being incorporated herein by reference.

### BACKGROUND OF THE INVENTION

1. Field of the Invention

This invention relates to a method for treating a substrate and more particularly, to a method for treating a substrate by a single wafer processing using chemicals.

2. Description of the Related Art

In the wet steps (surface cleaning, oxide film etching, resist stripping and the like) of a semiconductor manufacturing process, the surface treatment of substrates using a rotary single wafer processing apparatus has been conducted.

More particularly, a substrate (also called “wafer”) is held in a hold member mounted in a processing chamber of a single water processing apparatus and the hold member is rotated. Next, a chemical such as diluted hydrofluoric acid (DHF), sulfuric acid (H₂SO₄), SPM (H₂SO₄/H₂O₂), BHF (buffered hydrofluoric acid), ammonia-hydrogen peroxide (HN₄OH/H₂O₂) or the like is supplied to a region closer to the rotation center from a liquid discharge nozzle disposed above or obliquely upward the hold member. While the chemical is moved toward the outer periphery of the substrate by centrifugal force, an intended surface treatment is carried out. After completion of the surface treatment, pure water is supplied to the substrate surface from the liquid discharge nozzle for cleaning, thereby removing the chemical component therefrom.

In the course of the cleaning treatment with pure water, when pure water whose specific resistance is as high as 18 MΩ/cm is in contact with a region of the substrate surface where pure water is discharged, static electricity generates owing to the friction between the substrate surface and the pure water, thereby causing the substrate surface to be locally charged. As is known in the art, this leads to failures such as breakage of a gate oxide film, dissolution of metal films serving as wiring and electrodes and the like. To cope with this, usual practice is to lower the specific resistance of pure water by adding, to pure water, carbon dioxide (CO₂) or ammonia (NH₃) gas thereby preventing the substrate from being charged (see, for example, Japanese Patent Laid-open No. 2002-373879).

### SUMMARY OF THE INVENTION

Where such a chemical as BHF (buffered hydrofluoric acid) or SPM (H₂SO₄/H₂O₂) is used for etching treatment of an oxide film or resist stripping, a field oxide film or gate oxide film formed on the substrate surface is locally broken upon the discharge of the chemical, thereby causing the substrate to be locally damaged. The local damage of the substrate presents a problem in that the product yield lowers.

In order to solve the above problems, an embodiment of the invention contemplates to provide a method for treating a substrate wherein a chemical is fed to a surface of the substrate, the method including the steps of: initially feeding a liquid whose electric conductivity is lower than the chemical to a surface of the substrate so as to wet at least a region where the chemical is to be discharged; and discharging the chemical to the region to treat the surface of the substrate with the discharged chemical.

It is preferred that the chemical is discharged in a condition where the liquid has been fed entirely over the surface of the substrate.

It is also preferred that the liquid is fed to the surface of the substrate in such a way that the surface of the liquid is raised by surface tension of the liquid.

Preferably, when the liquid is fed to the substrate, the substrate is rotated.

Preferably, when the chemical is discharged against the substrate, the substrate is rotated.

According to the treating method of the substrate according to embodiments of the invention, when the substrate surface is in contact with the chemical, local damage of the substrate surface against which the chemical is discharged can be suppressed. Accordingly, the yield of devices using such a substrate can be improved.

### BRIEF DESCRIPTION OF THE DRAWINGS

FIGS. 1A and 1B are, respectively, a schematic view illustrating a treating method of a substrate in related art;

FIG. 2 is a photograph showing a local damage on a substrate surface according to the treating method in related art;

FIGS. 3A to 3E are, respectively, illustrative views illustrating how a local damage is caused on a substrate when using the treating method of a substrate in related art;

FIG. 4 is a photograph showing a section of a local damage occurring in a substrate according to the treating method in related art;

FIGS. 5A and 5B are, respectively, graphs including a graph showing the relation between the incidence of Si breakage and the type of chemical and a graph showing the relation between the incidence of Si breakage and the electric conductivity, each obtained according to the treating method in related art;

FIGS. 6A to 6C are, respectively, a schematic view showing a step embodying a method for treating a substrate according to the invention; and

FIG. 7 is a graph showing, for comparison, substrate damage incidences in the treating method in related art and also in the substrate treating method embodying the invention.

### DETAILED DESCRIPTION OF THE PREFERRED EMBODIMENT

The treating method of a substrate according to an embodiment of the invention is described with reference to the accompanying drawings. The treating method of a substrate according to the invention is applicable to a substrate wherein an insulating layer such as of SiO₂, SiN or the like is exposed or laminated (e.g. an SOI (Silicon On Insulator) substrate wherein an Si support substrate, an SiO₂ insulating layer and an Si semiconductor layer are successively laminated).

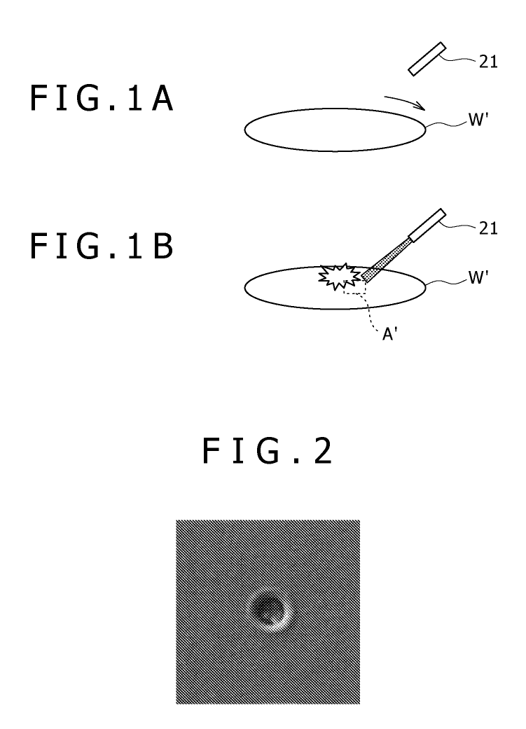

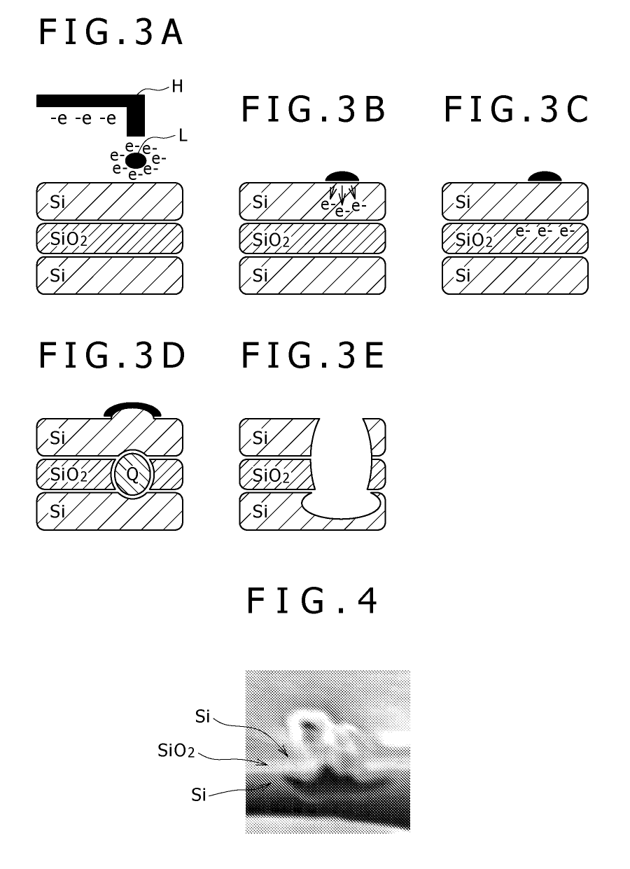

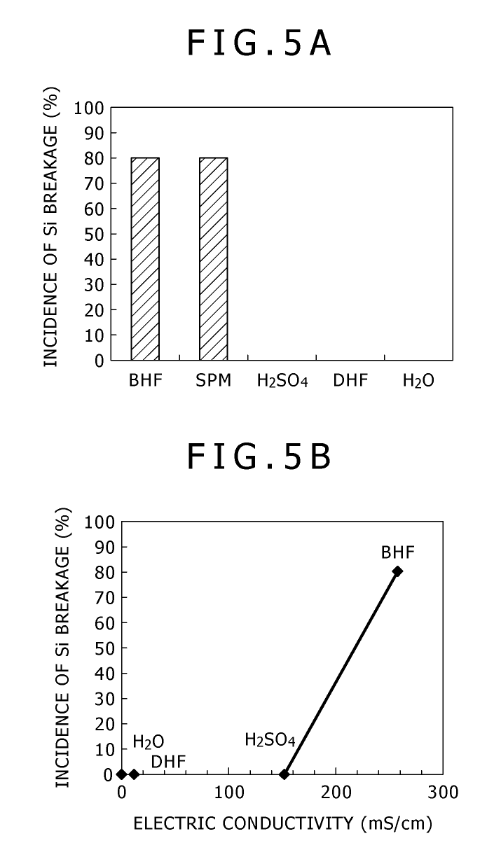

Initially, how a local damage occurs on a substrate surface in a treating method of a substrate in related art is illustrated with reference to the accompanying drawings. FIGS. 1A and 1B are, respectively, a schematic view illustrating a treating method of a substrate in related art. FIG. 2 is a photograph showing a local damage on a substrate surface according to the treating method in related art. FIGS. 3A to 3E are, respectively, illustrative views illustrating how a local damage is caused on a substrate when using the treating method in related art. FIG. 4 is a photograph showing a section of a local damage occurring in a substrate according to the treating method in related art. FIGS. 5A and 5B are, respectively, a graph showing the relation between the incidence of Si breakage and the type of chemical and a graph showing the relation between the incidence of Si breakage and the electric conductivity, each obtained according to the treating method of the substrate in related art.

Where a chemical such as BHF or SPM is used for oxide film etching treatment or resist stripping as stated hereinabove, a field oxide film or gate oxide film formed on a surface of a substrate (which may also be called “wafer”) is locally broken when the chemical is discharged, thereby causing a local damage on the substrate.

We made intensive studies and, as a result, found that the local damage is caused by flow-induced electrification (frictional charging phenomenon) occurring between a chemical and a pipe (nozzle) through which the chemical passes.

More particularly, the chemical such as BHF used for etching treatment of an oxide film or SMP used for resist stripping is very high in degree of ionization and thus, concentrations of various types of ions contained in the liquid are so great that electric conductivity becomes high.

Accordingly, where chemical L having high electric conductivity is supplied from a nozzle 21, formed of a fluorine resin and provided above a substrate W′, as shown in FIG. 1B to the surface of the substrate W′ being rotated as shown in FIG. 1A, no frictional electrification takes place between the chemical L and the substrate W′. Nevertheless, the chemical L is greatly charged by the action of the flow electrification (frictional electrification phenomenon) between the chemical L and a pipe through which the chemical passes.

When the chemical L being charged is discharged from the nozzle 21, a region A′ of the substrate in contact with the chemical L is in such a condition that the electric charges abruptly flow from the chemical L toward the substrate W′. This permits the field oxide film or gate oxide film at the region A′ in contact with the chemical L on the surface of the substrate W′ to be locally broken, thereby causing a local damage to be formed on the substrate W′ as is particularly shown in FIG. 2. The damage imparted to the substrate W′ leads to the lowering of product yield.

It is assumed that the local damage of the substrate W′ caused by abrupt flow of electric charges from the chemical L to the substrate W′ occurs in the following way. In the following illustration, an SOI substrate is used as the substrate W′.

As shown in FIG. 3A, the chemical L charged by the flow electrification between the chemical L and the pipe H through which the chemical L passes is in contact with the surface of the substrate W′, whereupon as shown in FIG. 3B, the charges move through an Si semiconductor layer to the inside of an SiO₂ insulating layer. As shown in FIG. 3C, the SiO₂ insulting layer is electrically charged locally.

Thereafter, as shown in FIG. 3D, the charges flow via the SiO₂ insulating layer to the Si support substrate, under which Joule heat generates to cause high temperatures locally. As shown in FIG. 3E, the Si support substrate is locally melted and part of the Si support substrate is swollen and blown out by the influence of the generated gas. The sectional structure of the substrate at this stage is just as shown in FIG. 4.

FIGS. 5A and 5B show the relation between the local damage occurring in the substrate W′ and the electric conductivity for different types of chemicals. As shown in FIG. 5A, it will be seen that the local damage occurring at the substrate W′ takes place for SPM and BHF, with little or no occurrence for H₂SO₄, DHF and H₂O. When graphed as electric conductivity for different types of chemicals, FIG. 5B is obtained. As shown, such local damage as set out above does not take place when using chemicals (H₂SO₄, DHF and H₂O) whose electric conductivity is not greater than 160 mS/cm.

In view of the above, when a chemical is discharged to a region to be discharged with the chemical under conditions where a liquid whose electric conductivity is lower than the chemical has been preliminarily fed, local damage can be suppressed. In particular, when a liquid whose electric conductivity is not higher than 160 mS/cm has been preliminarily fed, local damage can be significantly suppressed after subsequent discharge of a chemical.

This is for the reason that when the surface of the substrate is in initial contact with a chemical, the liquid whose electric conductivity is low serves as a buffer to prevent the chemical having high electric conductivity from contacting with the surface of the substrate. This leads to suppression of local charges due to the electrostatic friction phenomenon of the region of the substrate surface at which the chemical is discharged.

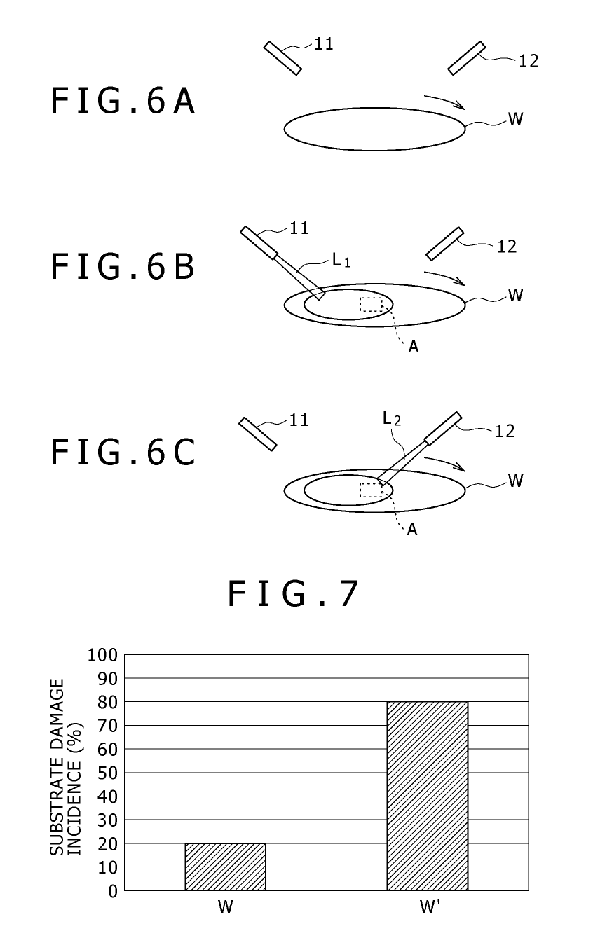

An embodiment of the invention is described in detail with reference to the accompanying drawings. The treating method of a substrate illustrated herein is an instance of etching a surface of the substrate by means of BHF. FIGS. 6A to 6C are, respectively, a process chart illustrating a method of treating a substrate according to an embodiment of the invention, and FIG. 7 is a graph showing, for comparison, substrate damage incidences in a treating method of the substrate in related art and also in a treating method of the substrate of this embodiment.

As shown in FIG. 6A, a substrate W wherein an oxide film is left, for example, is introduced into a treating chamber of a single wafer processing apparatus, not shown herein, and the substrate W is held with a hold member provided within the treating chamber. It will be noted that a 12 inch-size substrate W is used for one instance.

The treating chamber has therein a first nozzle 11 which is provided above the hold member and through which a liquid L₁ whose electric conductivity is lower than a chemical L₂ is fed to a surface of the substrate W held with the hold member, and a second nozzle 12 feeding the chemical L₂ to the surface of the substrate W. While keeping the substrate W horizontal, the hold member is rotated. It will be noted that the first nozzle 11 and the second nozzle 12 are each made of a fluorine resin.

Next, as shown in FIG. 6B, the liquid L₁ whose electric conductivity is lower than the chemical L₂ is fed from the first nozzle 11 to the surface of the substrate W so as to wet at least a region A to be discharged with the chemical L₂, thereby carrying out a pre-wetting treatment.

The liquid L₁ whose electric conductivity is lower than the chemical L₂ is a liquid whose electric conductivity is controlled at about 0 mS/cm to 160 mS/cm. The liquid L₁ should be an inert liquid which does not react with materials for devices on the substrate W. It is to be noted that “a liquid L₁ whose electric conductivity is lower than L₂” means a liquid L₁ is higher in degree of ionization than a chemical L₂, or concentrations of ions contained in a liquid L₁ is greater than a chemical L₂.

As will be described later, BHF is used as a chemical L₂ in this case. Therefore, an inert liquid whose electric conductivity is lower than BHF is used as a liquid L₁. The inert liquid having such a low electric conductivity as mentioned above includes, for example, pure water added with CO₂ gas (CO₂ water) thereto or pure water added with NH₃ gas. CO₂ water whose electric conductivity is controlled at about 0.67 mS/cm is fed herein, for example.

When the liquid L₁ is fed to the surface of the substrate W, the feed of the liquid L₁ is set within a range, for example, of 25 ml to 300 ml and the rotation frequency of the substrate W is set at not greater than 50 r.p.m., preferably not greater than 20 r.p.m., under which the liquid is fed in such a way that the liquid surface is raised by surface tension. It will be noted that the liquid L₁ may be in a condition of being fed to the entire surface of the substrate by increasing the rotation frequency of the substrate W to flow the chemical L₂ toward the outer periphery.

This allows a chemical to be discharged in the liquid L₁ having a thickness covering the region A therewith in a subsequent step of feeding the chemical L₂ described hereinlater, with the result that the liquid L₁ serves as a buffer and thus, a direct contact of the chemical L₂ having high electric conductivity with the surface of the substrate W can be prevented. It is to be noted that although the liquid L₁ has been fed herein while rotating the substrate W, the liquid may be fed under rotation-free conditions.

Next, as shown in FIG. 6C, the chemical L₂ made, for example, of BHF (HF:NH₄F=1:15) is discharged to the region A to which the liquid L₁ has been preliminarily fed, and the feed of the liquid L₁ is stopped. The chemical L₂ used herein is a liquid whose electric conductivity is as high as 252 mS/cm.

As stated above, since the liquid L₁ is fed in such a condition as to be attracted or raised on the region A by surface tension, the chemical L₂ is discharged into the liquid L₁. Thus, the chemical L₂ made of BHF is in contact with the liquid L₁, which permits the electric conductivity at the contact of the region A between the liquid L₁ and the chemical L₂ to be suppressed, thereby preventing local and abrupt discharge.

Thereafter, the rotation frequency of the substrate W increases to cause the chemical L₂ to be flown toward the outer periphery. In this way, the oxide film on the substrate W is removed by means of the chemical L₂ fed to the surface of the substrate W thereby performing the surface treatment of the substrate W.

At this stage, the rotation frequency of the substrate W gradually increases to a range, for example, of 300 r.p.m. to 1200 r.p.m., and the liquid covering the surface of the substrate W is changed from a mixed state of the liquid L₁ and chemical L₂ to the chemical L₂ so as not to permit the friction between the chemical L₂ and the substrate W to increase sharply.

This enables the electric charges over the entire surface of the substrate W to be suppressed, and the surface treatment of the substrate W can be carried out in a condition where no liquid L₁ is left, for which the surface treatment of the substrate W can be performed without worsening the treating performance of the chemical L₂. The feed of the chemical L₂ is set, for example, within a range of 500 ml to 1500 ml.

According to this treating method the substrate W, with the case where the chemical L₂ whose electric conductivity is high is fed, the chemical L₂ can be fed to the region A to be discharged with the chemical L₂ in such a state that the liquid L₁ whose electric conductivity is lower than the chemical L₂ has been preliminarily fed.

When the chemical L₂ is in initial contact with the surface of the substrate W, the liquid L₁ having a lower electric conductivity serves as a buffer, with which the chemical L₂ having a higher electric conductivity is prevented from contacting the surface of the substrate W.

In this way, when the chemical L₂ electrically charged owing to the flow charge phenomenon with a pipe is discharged to the surface of the substrate W, the local charges of the region discharged with the chemical L₂ can be suppressed, thereby leading to an improvement in device yield when using this substrate W.

According to the treating method of the substrate W of this embodiment, the liquid L₁ is fed to the surface of the substrate W so that the surface of the liquid L₁ is raised owing to surface tension and thus, the buffering effect of the liquid L₁ becomes more conspicuous.

FIG. 7 shows the results of measurement of a substrate damage incidence for the substrate W obtained after treatment by application of the treating method of the above embodiment illustrated with reference to FIGS. 6A to 6C and the non-treated substrate W′. It will be noted that the chemical L₂ used to treat the substrate W, W′ was BHF and the liquid L₁ preliminarily fed to the surface of the substrate W was CO₂ water.

As shown in the figure, it has been confirmed that the substrate W is significantly suppressed over the substrate W′ with respect to the substrate damage.

It is to be noted that although, in the above embodiment, an instance using BHF as the chemical L₂ has been illustrated, similar results are obtained when using SPM as the chemical L₂. This is for the reason that the CO₂ water used as the liquid L₁ is lower in electric conductivity than SPM used as the chemical L₂, whereby a local substrate damage can be suppressed ascribed to the charge phenomenon occurring between the pipe and the chemical L₂. Besides, the chemical L₂ includes APM, HPM, HCl, DHF, HF/HNO₃, HNO₃/HCl, H₂SO₄/O₃, HNO₃ or the like.

In the above embodiment, the instance wherein the substrate W is surface treated has been illustrated. The invention is applicable to the treatment of the substrate W on the back side thereof.

As having been described hereinabove, according to the treating method of a substrate of the invention, when the surface of the substrate is initially in contact with a chemical, local charges caused by the electrostatic frictional phenomenon on the substrate surface are suppressed, for which the damage ascribed to the charges on the substrate surface at a region where the chemical is to be discharged can be suppressed. Accordingly, the device yield using this substrate can be improved.

It should be understood by those skilled in the art that various modifications, combinations, sub-combinations and alternations may occur depending on design requirements and other factors insofar as they are within the scope of the appended claims or the equivalent thereof.

What is claimed is:

1. A method for treating a substrate wherein a chemical is fed to a surface of the substrate, the method comprising the steps of:
initially feeding a liquid whose electric conductivity is lower than the chemical to a surface of said substrate so as to wet at least a region where said chemical is to be discharged, and
discharging said chemical to said region to treat the surface of said substrate with the discharged chemical.

2. The method according to claim 1, wherein said liquid is fed to an entire surface of said substrate, under which said chemical is discharged.

3. The method according to claim 1, wherein said liquid is fed to the surface of said substrate in such a way that a surface of said liquid is raised by surface tension.

4. The method according to claim 1, wherein when said liquid is fed to said substrate, said substrate is rotated.

5. The method according to claim 1, wherein when said chemical is discharged against said substrate, said substrate is rotated.
